(19) United States
(12) Patent Application Publication
(10) Pub. No.: US 2026/0087834 A1
(43) Pub. Date: Mar. 26, 2026

(54) DETERMINING THE DEGREE OF COOKING OF FOOD

(71) Applicant: BSH Hausgeräte GmbH, Munich (DE)

(72) Inventors: Karol Badowski, Olsztyn (PL); Ramon Peinado Adiego, Zaragoza (ES); Hector Martinez Landa, Zaragoza (ES); Ana Belen Cambra Lines, Zaragoza (ES); Hans-Martin Eiter, Kirchweidach (DE); Alejandro Rituerto Sin, Zaragoza (ES); Jorge Escribano Jimenez, Zaragoza (ES); Sergio Gracia Bosque, Zaragoza (ES); Soraya Santana De la Fe, Zaragoza (ES); Blanca Grillo Zamora, Zaragoza (ES)

(21) Appl. No.: 19/109,627

(22) PCT Filed: Sep. 19, 2023
(86) PCT No.: PCT/EP2023/075802

§ 371 Date: Mar. 7, 2025

(30) Foreign Application Priority Data
Sep. 28, 2022 (EP) 22382894.8

(51) Int. Cl. G06V 20/68; F24C 7/08

(52) U.S. Cl. CPC G06V 20/68; F24C 7/085

(57) ABSTRACT

In a method for determining a degree of cooking of food to be cooked treated in a household cooking appliance, an image of the food to be cooked is recorded by a cooking chamber camera. A regression analysis algorithm based on an AI model an actual degree of cooking value representing a measure of a degree of cooking is output from the image, and an action is triggered based on the an actual degree of cooking value.

The invention relates to a method for determining a degree of cooking of food to be cooked, treated in a household cooking appliance, wherein at least one image of the food to be cooked is recorded by means of a cooking chamber camera, from the at least one image, an algorithm based on at least one AI model outputs an actual degree of cooking value representing a measure of the degree of cooking, and at least one action is triggered on the basis of the actual degree of cooking value. The invention also relates to a household cooking appliance, wherein the household cooking appliance has a cooking chamber and a cooking chamber camera and is designed to allow the method to proceed. The invention is particularly advantageously applicable to ovens.

EP 3 477 206 A1 discloses a cooking appliance comprising a cooking chamber and an imaging apparatus for recording an image of a food item within the chamber. A computing apparatus can be configured to calculate a parameter for the food based on the captured image which can be displayed on a user interface. A data processing facility is in communication with a camera and includes a software module configured to receive the recorded image from the camera and calculate a degree of browning. A user interface is configured such that it displays a visual scale indicating the degree of browning.

US 2021/0137311 A1 discloses an AI (artificial intelligence) apparatus comprising a cooking unit configured to cook a food by applying heat; a memory, configured to store a cooking class classification model for determining a degree of a cooking class of a food; a camera configured to capture the food, and a processor, configured to determine a degree of a cooking class from an image of the recorded food using the cooking class classification model in order to determine whether the determined level of the cooking class is identical to a degree of a user preference class, and if the determined level of the degree of cooking is identical to the level of the user preference class as a result of determining, controlling the cooking unit in order to end cooking of the food. Training data, which is used for supervised learning of the cooking class classification model, can be identified by a cooking class and the cooking class classification model can be trained using the identified training data. There is a plurality of cooking classes depending on the degree of cooking. For example, the degrees of cooking can be categorized into a first stage (very lightly cooked), a second stage (lightly cooked), a third stage (moderately cooked), a fourth stage (moderately to thoroughly cooked), a fifth stage (thoroughly cooked) and a sixth stage (very thoroughly cooked). The cooking class classification model can be trained for the purpose of exactly inferring one identified cooking class from the state of the recorded food image. The cooking state class classification model can determine model parameters, which are included in an artificial neural network, in order to minimize a cost function by way of supervised learning.

It is the object of the present invention to at least partially overcome the drawbacks of the prior art and, in particular, to provide an improved possibility for setting and monitoring a degree of cooking, in particular a degree of browning, with artificial intelligence methods.

This object is achieved according to the features of the independent claims. Preferred embodiments can be found, in particular, in the dependent claims.

The object is achieved by a method for determining a degree of cooking of food to be cooked, treated in a household cooking appliance, wherein
at least one image of the food to be cooked is recorded by means of a cooking chamber camera,
from the at least one image, a regression analysis algorithm based on at least one AI model outputs an actual degree of cooking value representing a measure of the degree of cooking, and
at least one action is or can be triggered on the basis of the actual degree of cooking value.

The regression analysis algorithm thus does not use, for example in contrast to US 2021/0137311 A1, a categorization into number-limited cooking classes, but analyzes the at least one image and calculates therefrom an actual degree of cooking value in the form of a number whose value range is basically continuous. The at least one AI model has been trained to calculate the actual degree of cooking value on the basis of the input at least one image. It does not require pretrained classes, but operates in a continuous space or a continuous domain. This in turn provides the advantage that the household cooking appliance can offer a user a greater breadth of cooking results which can be achieved without being restricted to pre-trained classes. A further advantage is that the actual degree of cooking value can be used to monitor, and possibly control, a cooking process before the end of a cooking time with high accuracy.

The degree of cooking is, in particular, a measure of a state of the food to be cooked on the basis of cooking. As already indicated above, the actual degree of cooking value is a numerical value from a continuous sample space of the algorithm. The actual degree of cooking value corresponds to the current degree of cooking value of the food to be cooked calculated from the image.

The household cooking appliance can be, for example, an oven, a steam cooking appliance, a microwave oven or any combination thereof, for example an oven with a steam treatment and/or microwave function. The household cooking appliance can have a cooking chamber which can be loaded with food to be cooked and whose, in particular front-side, loading opening can be closed by a door.

The cooking chamber camera is, in particular, a digital camera, in particular a color camera. The cooking chamber camera is configured and arranged to record images of the cooking chamber, with food to be cooked present in the cooking chamber, in particular, also then being mapped in the images.

The fact that an image of the food to be cooked is recorded by means of a cooking chamber camera can comprise the fact that the food to be cooked is recorded together with the surroundings of the food to be cooked (for example, a cooking chamber wall, a food carrier, etc.). It is a development that the at least one image, which is supplied as an input to the AI model-based regression analysis algorithm, also shows the surroundings of the cooking chamber. It is a development that only pixels or image sections of the at least one image showing the food to be cooked are supplied to the algorithm. The separation of the image section showing the food to be cooked from a recorded image can be carried out by means of basically known methods, such as object recognition, etc.

The at least one AI model can comprise or have as a basis an AI model or a plurality of AI models.

The regression analysis algorithm based on the at least one AI model can include linear regression or nonlinear regression, such as non-parametric regression, semi-parametric regression, or robust regression. The linear regression can advantageously be implemented and evaluated in a particularly simple manner. The at least one AI model can comprise one or more artificial neural network(s).

A regression analysis algorithm based on at least one AI model is taken to mean, in particular, an algorithm, which processes the input at least one image with the aid of at least one trained AI model and, as a result, outputs a numerical value, namely the actual degree of cooking value. The at least one AI model is consequently trained to determine the degree of cooking from the input image. Training or teaching can be carried out within the context of machine learning, in particular supervised learning. Training is taken to mean the ability of artificial intelligence to simulate laws. The regression represents, in particular, the learning algorithm. The training can be carried out, for example, with the aid of data determined experimentally, with the aid of data of a dedicated training database, with the aid of simulated data such as brightened and/or darkened measurement images, rotations, reflections, images with reduced contrast, color shifts, etc.

That the regression analysis algorithm outputs the actual degree of cooking value from or based on the at least one image comprises, in particular, that the at least one image is used as a starting point or basis or input dataset for the regression analysis algorithm. This can include the pixels or pixel values of the image (or a part thereof) being used as input variables for the regression analysis algorithm. It is a development that it is not the pixel values of the image as such, but variables derived therefrom, such as what is known as a feature vector, are used as input variables for the regression analysis algorithm.

That at least one action can be triggered on the basis of the actual degree of cooking value comprises, in particular, that at least one action is triggered if the actual degree of cooking value (for example, as the absolute value or percentage value) or a value derived therefrom (for example, a ratio or a difference from a desired value) satisfies a particular criterion, for example reaches a particular threshold value. Various actions can be triggered by the satisfying of different criteria.

It is an embodiment that the regression analysis algorithm outputs the actual degree of cooking value from exactly one image. In other words, the regression analysis algorithm uses exactly one image to calculate the actual degree of cooking value. This is advantageous in order to keep computing power low and advantageously also results in a particularly rapid calculation of the actual degree of cooking.

It is an embodiment that a plurality of images of the food to be cooked are recorded in a temporal sequence by means of a cooking chamber camera, and the regression analysis algorithm outputs the plurality of images an actual degree of cooking value representing a measure of the degree of cooking. In other words, the regression analysis algorithm uses an image sequence to calculate the actual degree of cooking value. This is advantageous in order to be able to determine the actual degree of cooking in a particularly accurate and robust or less error-prone manner. The image sequence can comprise, for example, a number of n images last recorded for carrying out the method (“synchronized window”), or it is possible, for example, to use the images recorded for carrying out the method since the start of the method, with the number of images then increasing as the cooking time progresses, for example up to 80 or even more images recorded at different times. When using a plurality of images, particular images can be given a higher weight in the calculation of the actual cooking degree value by the regression analysis algorithm. For example, the first image can be weighted higher in a cooking process than the following images.

It is an embodiment that it is checked whether the actual degree of cooking value has reached a desired degree of cooking value, and then a cooking process is ended as the at least one action. Thus, the advantage is achieved that a final cooking state of the food to be cooked, which is mapped by the desired degree of cooking value, may be achieved automatically. It is a development that the cooking process is ended if a difference between the actual degree of cooking value and the desired degree of cooking value reaches the value zero. It is a development that the actual degree of cooking value is output by the algorithm as a percentage value of the desired cooking degree value. It is a development that the actual degree of cooking value is output by the algorithm as a difference from the desired degree of cooking value. However, the actual degree of cooking value and the desired degree of cooking value are not limited to percentage values and can basically be any values.

The desired degree of cooking value can be set by the user, for example via a user interface of the household cooking appliance or via an application program (“App”) running on a user terminal such as a smartphone or tablet. However, the desired degree of cooking value can also be taken over from a cooking program or an electronic cookbook, possibly after adaptation or modification by a user.

The desired degree of cooking value can basically be set to any possible value of the actual cooking degree value which can be output by the algorithm. It is a development that household cooking appliance is designed to selectively provide only those desired cooking degree values which allow a meaningful cooking result. For example, a desired degree of cooking value of 0% can be excluded since this does not correspond to a cooking treatment. It is also possible to exclude-for example in a manner dependent on food to be cooked desired degree of cooking value, which do not allow a valid cooking result, for example because the product to be cooked would very likely then be burnt or burned.

It is an embodiment that the desired degree of cooking value can be set on a continuous or quasi-continuous scale. This advantageously enables a particularly high variability in the selection of the desired cooking degree value. The scale can be a percentage scale. Such a scale can range, for example, from 10% (keeping warm) over 60% (“rare”), 70% (“medium rare”), 80% (“medium”), 90% (“well done”) to 100% (“cross”) or even more than 100%, for example in quasi-continuous steps of 1% or 5%.

It is an embodiment that the desired degree of cooking value can be set on a sliding scale, wherein the stages of the scale are predetermined setting ranges of the basically continuous desired cooking degree value. Thus, the advantage is achieved that the input of the desired cooking degree value is simplified. Such a scale can offer, for example, only the stages 10 % (keeping warm) over 60% (“rare”), 70% (“medium rare”), 80% (“medium”), 90% (“well done”) and 100% (“cross”). This grading can be implemented independently of the calculated actual degree of cooking value and thus does not require any classification calculation, change or additional teaching of the AI model. In particular in this embodiment, an image or a color field, corresponding to one stage, can alternatively or additionally be displayed instead of numerical values of the desired cooking degree value.

It is an embodiment that the number and/or position of the stages on the scale can be varied by the user. This provides the advantage that a user can determine for themselves how precisely they can set the desired degree of cooking value.

It is an embodiment that at least one action is triggered during a cooking process on the basis of the actual degree of cooking value. As a result, the advantage is achieved that it is also possible to react to an event dependent on the actual degree of cooking value during the cooking process.

It is an embodiment that, as the at least one action, at least one cooking parameter (i.e. an operating parameter which influences the cooking process of the food to be cooked) is varied on the basis of the actual degree of cooking value during a cooking process. As a result, the advantage is achieved that the cooking process itself may also be adapted with the aid of the actual cooking degree value. Variations of the at least one cooking parameter can include, for example:
selectively switching on and off cooking appliance functionalities, such as switching on and off hot air operation, switching on and off particular heating elements, introducing steam, switching on and off a microwave generator, switching on and off cooking chamber ventilation, automatic opening of the door to cool the cooking chamber atmosphere, etc.;
varying heating powers, varying positions and/or rotational speeds of a rotary antenna or a stirrer, etc.;
etc.

It is an embodiment that as the at least one action at least one message is output to a user on the basis of the actual degree of cooking value during a cooking process. As a result, the user can advantageously be informed about different phases or events during the cooking process. This information/these items of information can be output purely for information purposes without there being a requirement for the user to act, and/or to advise a user to execute an act, for example to turn the food to be cooked.

It is an embodiment that as the at least one action the cooking progress is displayed on the basis of the actual degree of cooking value. Thus, the advantage is achieved that the cooking progress can be represented to a user with a high level of accuracy. The cooking progress (for example represented as a bar graph) can be displayed, for example on a user interface of the household cooking appliance and/or on a user terminal, in particular a mobile user terminal such as a smartphone or tablet. The cooking progress can be calculated from the actual degree of cooking value calculated by the algorithm or can be calculated and output by the algorithm itself.

It is an embodiment that the cooking progress is displayed as the cooking end time and/or remaining cooking duration. This is particularly user-friendly. The cooking end time and/or the remaining cooking duration can therefore likewise be calculated from the actual degree of cooking value calculated by the algorithm or can be calculated and output by the algorithm itself.

It is a development that a user inputs the desired cooking end time, for example as a duration or as a time, and the household cooking appliance is designed to adjust the cooking process in such a way (for example, by setting a heating power) that the cooking process is ended when the cooking end time that is input by the user, possibly within a certain range, is reached.

It is an embodiment that the degree of cooking value is a browning value. As a result, the advantage is achieved that a parameter which can be ascertained well optically and which reliably represents a degree of cooking of many foods is used as the degree of cooking value. The algorithm therefore outputs an actual degree of browning as the actual degree of cooking value. A user inputs a desired degree of browning as the desired degree of cooking value and is not limited to a particular number of classes of degrees of browning. The degree of cooking value is not limited to the browning value, however, but can generally comprise optical changes in the surface of the food to be cooked which correlate with the degree of cooking. In addition or as an alternative to the browning value, this can also be, for example, other color changes, for example a changed shade of green of broccoli, changes in size, such as shrinking of slices of salami or mushrooms, etc., a reduction in a diameter of a round pizza, etc. In particular, the at least one AI model can select and weigh the relevant properties or features.

It is an embodiment that during a cooking process, images of the food to be cooked are recorded cyclically, for example every 30 seconds or every minute, and are supplied to the regression analysis algorithm and, more precisely, as already described above, individually or as an image sequence.

The object is also achieved by a household cooking appliance, wherein the household cooking appliance has a cooking chamber and a cooking chamber camera and is designed to allow the method as claimed in one of the preceding claims to proceed. The household cooking appliance can be embodied analogously to the method, and vice versa, and has the same advantages.

It is a development that the household cooking appliance has a data processing facility which is designed to allow the method to proceed. The data processing facility can be a control facility of the household cooking appliance.

It is a development that the household cooking appliance is designed to allow the method to proceed autonomously, i.e. without resorting to a data processing capacity of an external entity. This provides the advantage that the method can also proceed without coupling in terms of data of the household cooking appliance to the external entity.

It is a development that the household cooking appliance can be coupled to an external entity in terms of data, and the method can be allowed to proceed at least partially on the external entity. This provides the advantage that a computing power of the household cooking appliance can be kept low. The external entity can be, for example, a mobile user terminal, such as a smartphone or tablet, a network server or a cloud computer. The coupling in terms of data can take place, for example, via a communication module of the household cooking appliance, such as a WLAN module, an Ethernet module, a Bluetooth module, etc.

The properties, features and advantages of this invention described above as well as the manner in which they are achieved will become clearer and more comprehensible in conjunction with the following schematic description of an exemplary embodiment which will be explained in more detail in conjunction with the drawings, in which:

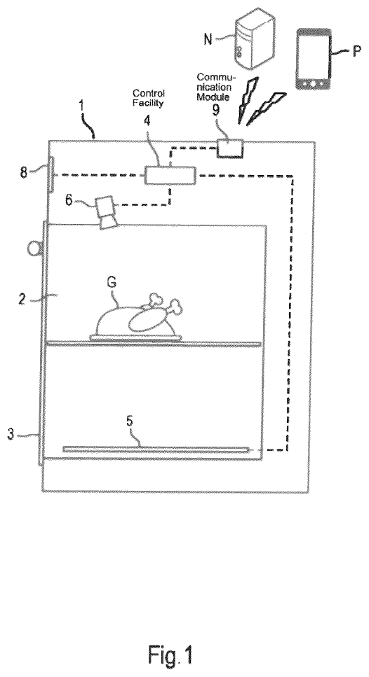

FIG. 1 shows, as a sectional illustration in side view, a simplified sketch of a household device in the form of an oven; and

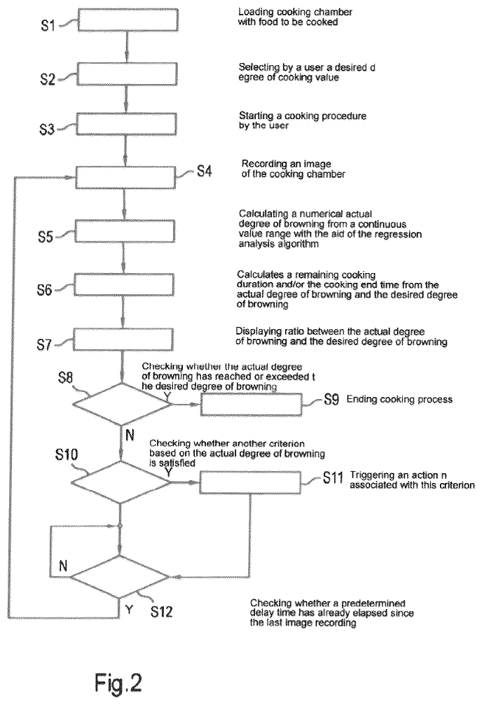

FIG. 2 shows one possible embodiment of the inventive method.

FIG. 1 shows, as a sectional illustration in side view, a simplified sketch of a cooking appliance in the form of an oven 1. The oven 1 has a cooking chamber 2 whose front loading opening can be closed by a pivotable door 3. The oven 1 also has a control facility 4 for carrying out operating processes, such as cooking and cleaning processes, as indicated here by an electrical bottom heating element 5 shown by way of example. The control facility 4 is also designed, for example programmed, as a data processing facility for carrying out the method. In particular, the regression analysis algorithm based on at least one AI model is implemented in the control facility 4.

A cooking chamber camera 6 in the form of a digital color camera is connected in terms of data to the control facility 4 and can record images from the cooking chamber 2 and transmit them to the control facility 4.

The oven 1 also has a user interface in the form of an operating panel 7 with an, in particular, touch-sensitive screen (“touchscreen”) on which, in a development, images, or sections thereof, recorded by the camera 6, which show, for example, only food to be cooked G present in the cooking chamber 2, can be displayed.

The oven 1 can also be equipped with a communication module 8 via which data from the control facility 4 and possibly recorded images can be transmitted to an external entity such as a user terminal, in particular to a mobile user terminal such as a smartphone P or tablet, etc. and/or to a network server N or cloud computer. The communication module 8 can comprise, for example, an Ethernet module, a WLAN module, a Bluetooth module, etc.

FIG. 2 shows one possible embodiment of the inventive method which is described in more detail with the aid of the oven 1. In this exemplary embodiment, the current actual degree of cooking respectively is calculated with the aid of exactly one image, wherein, however, a calculation of the current actual degree of cooking can basically also be carried out with the aid of an image sequence (top illustration).

In a step S1, the cooking chamber 2 is loaded with food to be cooked G by a user.

In a step S2, a user selects a desired degree of cooking value in the form of a desired degree of browning via the control panel 7, for example continuously or quasi-continuously or in stages.

In a step S3, the user starts a cooking procedure which is controlled by means of the control facility 4, for example by energizing the bottom heating element 5 and/or further heating elements (top illustration).

In a step S4, an image of the cooking chamber 2, which shows the food to be cooked G, is recorded by means of the cooking chamber camera 6 and transmitted to the control facility 4.

In a step S5, the control facility 4 calculates a numerical actual degree of browning from a continuous value range with the aid of the regression analysis algorithm implemented therein, from the image supplied to it as an input (that is to say, from the entire image or only from at least one image section, for example which only shows food to be cooked).

In a step S6, the control facility 4 calculates a remaining cooking duration and/or the cooking end time from the actual degree of browning and the desired degree of browning.

In a step S7, the, for example percentage, ratio between the actual degree of browning and the desired degree of browning, the remaining cooking time and/or the cooking end time is displayed to the user, for example on the control panel 7 or on the smartphone P.

In a step S8, the control facility 4 checks whether the actual degree of browning has reached or exceeded the desired degree of browning. If this is the case (“Y”), the cooking process is ended in step S9 and a corresponding message is possibly output to the user, for example via the control panel 7 or the smartphone P.

If this is not the case (“N”), the control facility 4 checks in a step S10 whether another criterion based on the actual degree of browning is satisfied. If the criterion is satisfied (“Y”), at least one action associated with this criterion is triggered in step S11, for example at least one cooking parameter is varied, at least one message is output to the user such as “Attention: only 10 min until cooking end time” or “Please turn food to be cooked”, etc.

Following a negative result of the check (“N”) in step S10 and in step S11, it is checked in a step S12 whether a predetermined delay time has already elapsed since the last image recording. If this is not the case (“N”), the check is continued. However, if this is the case (“Y”), the method branches back to step S4.

Of course, the present invention is not limited to the exemplary embodiment shown.

In general, “a”, “an”, etc. can be taken to mean a singular or a plurality, in particular in the sense of “at least one” or “one or more”, etc. as long as this is not explicitly excluded, for example by the expression “exactly one”, etc.

A numerical indication can also comprise exactly the specified number and a customary tolerance range, as long as this is not explicitly excluded.

### LIST OF REFERENCE NUMERALS

1 oven
2 cooking chamber
3 door
4 control facility
5 bottom heating element
6 cooking chamber camera
7 control panel
8 communication module
N network server
P smartphone
S1-S12 method steps

1-15. (canceled)

16. A method for determining a degree of cooking of food to be cooked treated in a household cooking appliance, the method comprising:
recording an image of the food to be cooked by a cooking chamber camera;
from the image, a regression analysis algorithm based on an AI model outputting an actual degree of cooking value representing a measure of a degree of cooking; and
triggering an action based on the actual degree of cooking value.

17. The method of claim 16, wherein the regression analysis algorithm outputs the actual degree of cooking value from exactly one image.

18. The method of claim 16, wherein a plurality of images of the food to be cooked is recorded in a temporal sequence by the cooking chamber camera and the regression analysis algorithm outputs the actual degree of cooking value from the plurality of images.

19. The method of claim 16, further comprising:
checking whether the actual degree of cooking value has reached a desired degree of cooking value, and
then ending a cooking process as the action.

20. The method of claim 19, further comprising setting the desired degree of cooking value on a continuous or quasi-continuous scale.

21. The method as claimed in 19, further comprising setting the desired degree of cooking value on a sliding scale, with stages of the sliding scale being predetermined setting ranges of the basically continuous desired degree of cooking value.

22. The method of claim 21, further comprising varying a number and/or position of the stages on the scale by a user.

23. The method of claim 16, wherein the action is triggered during a cooking process based on the actual degree of cooking value.

24. The method of claim 23, further comprising varying a cooking parameter based on the actual degree of cooking value when the action is triggered during the cooking process.

25. The method of claim 23, further comprising outputting a message to a user based on the basis of the actual degree of cooking value when the action is triggered during the cooking process.

26. The method of claim 16, further comprising:
calculating a cooking progress; and
displaying the cooking progress based on the actual degree of cooking value.

27. The method of claim 26, wherein the cooking progress is calculated and displayed as a cooking end time or remaining cooking duration.

28. The method of claim 16, wherein the degree of cooking value is a browning value.

29. The method of claim 16, wherein images of the food to be cooked are cyclically recorded and supplied to the regression analysis algorithm during a cooking process.

30. A household cooking appliance, comprising:
a cooking chamber;
a cooking chamber camera designed to record an image of the food to be cooked; and
a regression analysis algorithm based on an AI model to output from the image an actual degree of cooking value representing a measure of a degree of cooking,
wherein the household cooking appliance is designed to trigger an action based on the actual degree of cooking value.

31. The household cooking appliance of claim 30, wherein the cooking chamber camera is designed to record a plurality of images of the food to be cooked in a temporal sequence by the cooking chamber camera, with the regression analysis algorithm outputting the actual degree of cooking value from the plurality of images.

32. The household cooking appliance of claim 30, further comprising a control facility connected to the cooking chamber camera and designed to check whether the actual degree of cooking value has reached a desired degree of cooking value, causing a cooking process to end as the action.

33. The household cooking appliance of claim 32, further comprising a control panel or smartphone operably connected to the control facility to output a message to a user based on the basis of the actual degree of cooking value when the action is triggered during the cooking process.

34. The household cooking appliance of claim 32, wherein the regression analysis algorithm is implemented in the control facility.

35. The household cooking appliance of claim 30, further comprising:
a control facility connected to the cooking chamber camera and designed to calculate a cooking progress; and
a control panel or smartphone operably connected to the control facility to display a cooking end time or a remaining cooking duration.
